(19) United States
(12) Patent Application Publication
(10) Pub. No.: US 2019/0275587 A1
(43) Pub. Date: Sep. 12, 2019

(54) POWDER MATERIAL, METHOD FOR MANUFACTURING POWDER MATERIAL, METHOD FOR MANUFACTURING SOLID MODEL, AND SOLID MODELING APPARATUS

(71) Applicant: Konica Minolta, Inc., Tokyo (JP)

(72) Inventors: Masahiro MATSUOKA, Tokyo (JP); Ayumi YONEZAKI, Tokyo (JP)

(21) Appl. No.: 16/302,917

(22) PCT Filed: Jun. 7, 2017
(86) PCT No.: PCT/JP2017/021165

§ 371 Date: Nov. 19, 2018

(30) Foreign Application Priority Data
Jun. 14, 2016 (JP) 2016-118054

(51) Int. Cl. B22F 3/105; B22F 1/02; B22F 9/02

(52) U.S. Cl. CPC B22F 3/1055; B33Y 10/00; B22F 9/02; B22F 1/02

(57) ABSTRACT

The present invention is aimed to provide a powder material for the powder bed fusion method, the powder material enabling higher modeling speed and higher manufacturing precision. The present invention relates to a powder material containing a plurality of composite particles. The composite particles contain metal base particles having a number average particle diameter of 20-60 μm inclusive and low-heat-conductivity particles that adhere in an insular form to the surfaces of the base particles and that have a number average particle diameter of 100-300 nm inclusive. The heat conductivity of the low-heat-conductivity particles at 100° C. is 35.0 W/K·m or less, and the heat conductivity of the low-heat-conductivity particles at 100° C. is lower than the heat conductivity of a metal material at 100° C. contained as a main constituent of the metal base particles.

### TECHNICAL FIELD

The present invention relates to a powder material, a method of producing a powder material, a method of producing a three-dimensional object, and a three-dimensional shaping apparatus.

### BACKGROUND ART

In recent years, various methods that enable relatively easy production of three-dimensional objects of complicated shape have been developed. The three-dimensional objects thus produced are used in applications such as making of a prototype for testing of the shape and properties of an end product. The material for production of the three-dimensional objects is selected as appropriate according to the type of the end product or the properties to be tested using the prototype. For example, when the end product is a metallic machine part, a metal material may be used as the material of the prototype.

Production of a three-dimensional object from a metal material can be carried out by powder bed fusion process using particles containing, as a main component, a metal serving as the material of the three-dimensional object to be produced. In the powder bed fusion process, a powder material including the particles is spread flatly to form a thin layer, and a desired portion of the thin layer is selectively irradiated with a laser to sinter or fuse the particles to form a layer corresponding to one of the layers into which the three-dimensional object is divided in its thickness direction (hereinafter may be simply referred to as an “object layer”). The powder material is further spread over the formed layer, and the spread powder material is irradiated with a laser to selectively sinter or fuse the particles to form a next object layer. This procedure is repeated to stack object layers on top of one another and thus produce the three-dimensional object of desired shape.

In order to facilitate production of a three-dimensional object, a component other than the metal as the material of the three-dimensional object to be produced may be incorporated into the powder material.

For example, PTL 1 describes a powder material including copper particles having an average particle size of 1 μm to 80 μm, copper particles having an average particle size of 1 nm to 30 nm, and a dispersion medium such as polyvinylpyrrolidone. PTL 1 states that the addition of copper particles having a small average particle size to a powder material lowers the apparent melting point of the powder material, thus enabling sintering at lowered temperatures.

### CITATION LIST

### Patent Literatures

PTL 1 Japanese Patent Application Laid-Open No. 2013-161544

### SUMMARY OF INVENTION

### Technical Problem

The powder bed fusion process is expected to allow three-dimensional objects to be produced from any material as long as the material is capable of absorbing energy from a laser to undergo sintering or fusion. However, there is a demand for enabling three-dimensional objects to be produced more quickly for mass production of various kinds of end products or prototypes by the powder bed fusion process. Further, depending on the intended application of three-dimensional objects, there is a demand for producing the three-dimensional objects with higher precision.

According to PTL 1, the addition of copper particles having an average particle size of 1 nm to 30 nm to a powder material lowers the apparent melting point of the powder material. A lowered apparent melting point of the powder material is expected to facilitate sintering or fusion of the particles contained in the powder material and increase the building speed, thus enabling three-dimensional objects to be produced more quickly. However, an investigation by the present inventors has revealed that even the use of the powder material described in PTL 1 cannot yield a sufficiently increased building speed or sufficiently improved precision of the three-dimensional objects produced.

The present invention has been made in view of the above problems, and it is an object of the present invention to provide a powder material for powder bed fusion process, with which a faster building speed and a higher precision of a three-dimensional object produced can be achieved than with conventional powder materials. It is also an object of the present invention to provide a method of producing such a powder material, a method of producing a three-dimensional object using such a powder material, and an apparatus for producing a three-dimensional object.

### Solution to Problem

The present invention relates to the following powder material, the following method of producing a powder material, the following method of producing a three-dimensional object, and the following three-dimensional shaping apparatus.

[1] A powder material includes a plurality of composite particles, the powder material being intended for use in producing a three-dimensional object by selectively irradiating a thin layer of the powder material with a laser beam to form an object layer composed of the composite particles sintered or fused together and stacking the object layer on another, in which the composite particles comprise matrix metal particles having a number-average particle size of 20 μm or more and 60 μm or less and low thermal conductivity particles having a number-average particle size of 100 nm or more and 300 nm or less, the low thermal conductivity particles being attached in the form of islands to the surface of each matrix metal particle, and the low thermal conductivity particles have a thermal conductivity at 100° C. of 35.0 W/K·m or less, and the thermal conductivity at 100° C. of the low thermal conductivity particles is lower than a thermal conductivity at 100° C. of a metal material contained as a main component in the matrix metal particles.

[2] The powder material according to [1], in which a ratio (B/A) of the number-average particle size (B) of the low thermal conductivity particles to the number-average particle size (A) of the matrix metal particles is 0.005 or more.

[3] The powder material according to [1] or [2], in which the matrix metal particles have a particle size distribution with a coefficient of variation (CV value) of 15% or less.

[4] The powder material according to any one of [1] to [3], in which the low thermal conductivity particles have a particle size distribution with a coefficient of variation (CV value) of 15% or less.

[5] The powder material according to any one of [1] to [4], in which the low thermal conductivity particles contain a metal oxide as a main component.

[6] The powder material according to any one of [1] to [5], in which the degree of coverage of the surface of each matrix metal particle by the low thermal conductivity particles is 5% or more and 50% or less.

[7] The powder material according to any one of [1] to [6], in which a ratio (L/A) of an average (L) of distances between the adjacent low thermal conductivity particles on the surface of each matrix metal particle to the number-average particle size (A) of the matrix metal particles is 0.10 or less.

[8] A method of producing the powder material according to any one of [1] to [6] includes: providing matrix metal particles having a number-average particle size of 20 μm or more and 60 μm or less and low thermal conductivity particles having a number-average particle size of 100 nm or more and 300 nm or less and a thermal conductivity at 100° C. of 35.0 W/K·m or less, wherein the thermal conductivity at 100° C. of the low thermal conductivity particles is lower than a thermal conductivity at 100° C. of a metal material contained as a main component in the matrix metal particles; and attaching the low thermal conductivity particles to the surface of each matrix metal particle to fabricate composite particles.

[9] A method of producing a three-dimensional object includes: forming a thin layer of the powder material according to any one of [1] to [7] or the powder material produced by the method according to [8]; selectively irradiating the thin layer with a laser beam to sinter or fuse the composite particles contained in the powder material and form an object layer composed of the sintered or fused composite particles; and repeating the formation of the thin layer and the formation of the object layer in the order mentioned to stack the object layers on top of one another.

[10] A three-dimensional shaping apparatus includes: a build stage; a thin layer formation section that forms a thin layer of the powder material according to any one of [1] to [7] on or above the build stage; a laser irradiation section that irradiates the thin layer with a laser to form an object layer composed of the composite particles sintered or fused together; a stage support section supporting the build stage and capable of changing the position of the build stage in a vertical direction; and a control section that controls the thin layer forming section, the laser irradiation section, and the stage support section to repeat formation of the object layer and stack the object layers on top of one another.

### Advantageous Effects of Invention

According to the present invention, there are provided: a powder material for powder bed fusion process, with which a faster building speed and a higher precision of a three-dimensional object produced can be achieved than with conventional powder materials; a method of producing a three-dimensional object using such a powder material; and an apparatus for producing a three-dimensional object.

### BRIEF DESCRIPTION OF DRAWINGS

FIG. 1 is a schematic cross-sectional view of a composite particle according to an embodiment of the present invention.

FIG. 2 is a schematic partially-enlarged cross-sectional view of a powder material including composite particles according to the embodiment of the present invention.

FIG. 3 is a schematic cross-sectional view of a thin layer formed from a powder material including composite particles according to the embodiment of the present invention.

FIG. 4 is a side view schematically illustrating the configuration of a three-dimensional shaping apparatus according to an embodiment of the present invention.

FIG. 5 is a diagram illustrating main parts of a control system of a three-dimensional shaping apparatus according to an embodiment of the present invention.

### DESCRIPTION OF EMBODIMENTS

In order to solve the problems previously described, the present inventors have conducted intensive investigations as to powder materials for use in powder bed fusion process. As a result, the present inventors have found that the use of a powder material in fabricating a three-dimensional object by powder bed fusion process yields an increased building speed and at the same time an improved precision of the fabricated three-dimensional object when the powder material includes particles (which may be simply referred to as “composite particles” hereinafter) including: particles containing, as a main component, a metal serving as the material of the three-dimensional object (the particles may be simply referred to as “matrix metal particles” hereinafter); and fine particles attached in the form of islands to the surface of each matrix metal particle and having a lower thermal conductivity than the metal material contained as a main component in the matrix metal particles (the fine particles may be simply referred to as “low thermal conductivity particles” hereinafter).

In a thin layer formed from the powder material, the matrix metal particles are not in direct contact with each other, but are spaced at appropriate distances with the low thermal conductivity particles interposed therebetween. In the composite particles contained in the thin layer, the low thermal conductivity particles do not conduct heat of the matrix metal particles to the outside of the composite particles, and thus the heat is retained in the matrix metal particles. These factors are expected to reduce heat diffusion between the adjacent matrix metal particles in the thin layer.

With reduced heat diffusion between the adjacent matrix metal particles, it is expected that the matrix metal particles having absorbed energy from a laser are more quickly heated and sintered or fused and hence that the building speed can be increased. With reduced heat diffusion between the adjacent matrix metal particles, it is further expected that the matrix metal particles present in non-laser-irradiated regions are less likely to undergo sintering or fusion caused by conduction of heat to the matrix metal particles present in the non-laser-irradiated regions and hence that the precision of the three-dimensional object produced can be improved.

In order for the effect of the reduction in heat diffusion to be sufficiently exhibited, the thermal conductivity of the low thermal conductivity particles needs to be sufficiently low, and a sufficient distance needs to be provided between the adjacent matrix metal particles by the low thermal conductivity particles. If the adjacent matrix metal particles are excessively distant from each other, the matrix metal particles cannot be sintered or fused together, and the precision of the three-dimensional object is unfortunately reduced.

Thus, the present inventors conducted further investigations based on the above findings and have found that the above effects on increase in building speed and improvement in precision of the three-dimensional object produced are sufficiently exhibited when the low thermal conductivity particles attached to the surface of the matrix metal particles have a thermal conductivity at 100° C. (the simper term “thermal conductivity” as used hereinafter refers to a thermal conductivity at 100° C.) of 35.0 W/K·m or less and have a number-average particle size (the simpler term “average particle size” as used hereinafter refers to a number-average particle size) of 100 nm or more and 300 nm or less. This is presumably because, due to the low thermal conductivity particles having a sufficiently low thermal conductivity and the adjacent matrix metal particles being spaced at an appropriate distance by the low thermal conductivity particles, the heat diffusion is sufficiently reduced while the sintering or fusion of the adjacent matrix metal particles are not significantly impeded.

By contrast, in the powder material described in PTL 1, the added copper particles have an average particle size as small as 1 nm to 30 nm, and thus a sufficient distance is not provided between the matrix metal particles. Additionally, since the copper particles are merely mixed into the powder material, the matrix metal particles are often in direct contact with each other in the formed thin layer due to a failure of the copper particles to reside between the matrix metal particles. In particular, it is inferred that the copper particles and matrix metal particles having significantly different average particle sizes tend to be separated from each other in the powder material and therefore that the copper particles tend to fail to reside between the matrix metal particles. For these reasons, it is believed that the powder material described in PTL 1 cannot reduce heat diffusion between the adjacent matrix metal particles and therefore that the use of the powder material cannot yield a significant increase in the building speed or sufficient improvement in the precision of the three-dimensional object produced.

The present inventors have further found that it is sufficient for the low thermal conductivity particles to be attached in the form of islands to the surface of the matrix metal particles. This is expected to eliminate the need for the use of a large amount of the low thermal conductivity particles and thus reduce the change in properties of the three-dimensional object caused by the presence of the low thermal conductivity particles remaining as an impurity.

Hereinafter, typical embodiments of the present invention based on the above findings will be described in detail.

1. Powder Material

The present embodiment relates to a powder material used for producing a three-dimensional object by powder bed fusion process. The powder material includes particles (composite particles) including the matrix metal particles and the low thermal conductivity particles attached to the surface of each matrix metal particle. The powder material may further include materials other than the composite particles such as a laser absorber and a flow agent as long as the composite particles can be sintered or fused sufficiently by laser irradiation.

1-1. Composite Particles

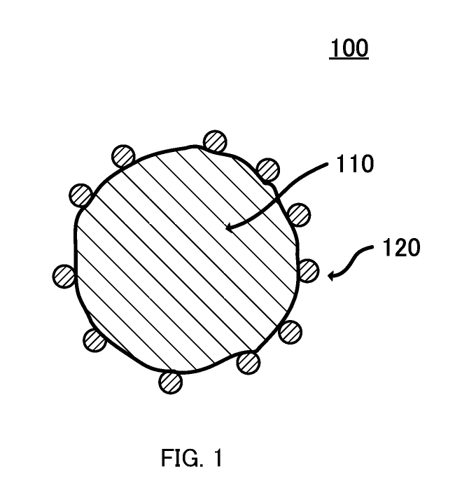

FIG. 1 is a schematic cross-sectional view showing the structure of a composite particle included in the powder material according to the present embodiment. As shown in FIG. 1, composite particle 100 includes matrix metal particle 110 and low thermal conductivity particles 120 attached to the surface of matrix metal particle 110. Composite particle 100 may further include a non-illustrated binder for binding matrix metal particle 110 and low thermal conductivity particles 120 together. Composite particle 100 do not need to include any binder when matrix metal particle 110 and low thermal conductivity particles 120 can be bound together by mechanical impact as described later.

1-1-1. Matrix Metal Particles 110

Matrix metal particles 110 are particles that contain as a main component a metal serving as the material of an object to be built and that have an average particle size of 20 μm or more and 60 μm or less.

Examples of the metal material contained as a main component in matrix metal particles 110 include aluminum, chromium, cobalt, copper, gold, iron, magnesium, silicon, molybdenum, nickel, palladium, platinum, rhodium, silver, tin, titanium, tungsten, zinc, and alloys of these elements. Examples of the alloys include brass, inconel, monel, nichrome, steel, and stainless steel. In order to uniformize the composition of the object to be finally obtained, matrix metal particles 110 preferably consist of one material. However, two materials may be used in combination as long as composite particles 100 can be formed.

A metal material the proportion of which in matrix metal particles 110 is the highest among metal materials identified by a known method such as fluorescent X-ray analysis can be defined as the metal material contained as a main component in matrix metal particles 110. Alternatively, the metal material contained as a main component in matrix metal particles 110 may be identified by separating matrix metal particles 110 and low thermal conductivity particles 120 from each other with a known method such as ultrasonication in a surfactant-containing aqueous solution and then subjecting resultant matrix metal particles 110 to fluorescent X-ray analysis or ICP optical emission spectroscopy.

When, among these metals, a metal material having a thermal conductivity of 100 W/K·m or more is contained as a main component in matrix metal particles 110, heat may be easily conducted between the adjacent matrix metal particles. However, the above structure of composite particles 100 can reduce thermal conduction between adjacent matrix metal particles 110. Thus, when matrix metal particles 110 contain such a metal material, the effect of the powder material according to the present embodiment which provides a faster building speed and a higher precision of the three-dimensional object produced than conventional powder materials is more evidently exhibited. The effect is more evident when the thermal conductivity of the metal material contained as a main component in matrix metal particles 110 is 150 W/K·m or more, and is still more evident when the thermal conductivity of the metal material contained as a main component in matrix metal particles 110 is 300 W/K·m or more.

Examples of metal materials having a thermal conductivity of 100 W/K·m or more include copper, aluminum, magnesium, tungsten, zinc, brass, and cobalt. Examples of metal materials having a thermal conductivity of 150 W/K·m or more include copper, aluminum, magnesium, and tungsten. Examples of metal materials having a thermal conductivity of 300 W/K·m or more include copper.

In order to increase the building speed and improve the precision of the three-dimensional object produced, the thermal conductivity of the metal material contained as a main component in matrix metal particles 110 is preferably 75 W/K·m or less, more preferably 50 W/K·m or less, and even more preferably 25 W/K·m or less.

Examples of metal materials having a thermal conductivity of 75 W/K·m or less include stainless steel, titanium, carbon steel, nickel-chromium steel, tin, iron, and bronze. Examples of metal materials having a thermal conductivity of 50 W/K·m or less include stainless steel, titanium, carbon steel, and nickel-chromium steel. Examples of metal materials having a thermal conductivity of 25 W/K·m or less include stainless steel and titanium.

Any of known values of the thermal conductivity of various metal materials can be employed as the value of the thermal conductivity of the metal material.

When the average particle size of matrix metal particles 110 is 20 μm or more, the flowability of the composite particles is increased so that a still faster building speed is achieved, in addition to which the composite particles can be spread more uniformly so that the precision of the three-dimensional object produced is improved. Furthermore, the fact that the average particle size is 20 μm or more is expected to allow each matrix metal particle 110 to be irradiated with a larger amount of laser beam and thus enable matrix metal particles 110 to be easily melted, so that the building speed is increased. Besides, when the average particle size is 20 μm or more, matrix metal particles 110 can be easily fabricated, so that increase in production cost of the powder material can be avoided. When the average particle size is 60 μm or less, a three-dimensional object can be produced with relatively high precision. In order to further increase the precision of the three-dimensional object produced, the upper limit of the average particle size of the matrix particles is preferably 50 μm, more preferably 40 μm, and still more preferably 30 μm.

The average particle size of matrix metal particles 110 can be determined as an average of particle sizes of 20 matrix metal particles 110 (the particle size of each particle is an average of the longest and shortest diameters) which are randomly selected in a cross-sectional view of composite particles 100 as observed with a transmission electron microscope (TEM). It is preferable that the average particle size be calculated for 20 randomly selected composite particles 100 and an average of the calculated values be defined as the average particle size of matrix metal particles 110 in the powder material. The average particle size of matrix metal particles 110 may be a number-average particle size determined by separating matrix metal particles 110 and low thermal conductivity particles 120 from each other with a known method such as ultrasonication in a surfactant-containing aqueous solution, then subjecting resultant matrix metal particles 110 to measurement with a laser diffraction/scattering particle size distribution analyzer (such as Partica LA-960 available from HORIBA, Ltd.), and making a calculation based on the measurement values on the assumption that the particles are spherical.

In order to uniformize the thermal conduction properties among composite particles 100, increase the building speed, and improve the precision of the three-dimensional object produced, the coefficient of variation (CV value) of the particle size distribution of matrix metal particles 110 is preferably 15% or less. In order to further increase the building speed and further improve the precision of the three-dimensional object produced, the CV value of matrix metal particles 110 is more preferably 10% or less and still more preferably 8% or less. A low CV value of matrix metal particles 110 is expected to allow for more uniform spreading of composite particles 100 in formation of a thin layer, thus resulting in an improvement in the precision of the three-dimensional object produced.

The CV value is determined as follows: particle sizes of 20 matrix metal particles 110 (the particle size of each particle is an average of the longest and shortest diameters) which are randomly selected in a cross-sectional view of composite particles 100 as observed with a transmission electron microscope (TEM) are measured, the standard deviation σ and average particle size D are calculated for the measured particles sizes, and the CV value is calculated as (σ/D)×100. The standard deviation σ and average particle size D of matrix metal particles 110 may be values determined by separating matrix metal particles 110 and low thermal conductivity particles 120 from each other with a known method such as ultrasonication in a surfactant-containing aqueous solution, then subjecting resultant matrix metal particles 110 to measurement with a laser diffraction/scattering particle size distribution analyzer (such as Partica LA-960 available from HORIBA, Ltd.), and making a calculation based on the measurement values on the assumption that the particles are spherical. The CV value is an index indicating the width of the particle size distribution, and a smaller CV value means that the particle size distribution is narrower.

Matrix metal particles 110 can be fabricated by any of known atomization techniques including gas atomization, water atomization, plasma atomization, and centrifugal atomization.

1-1-2. Low thermal conductivity particles 120

Low thermal conductivity particles 120 are particles attached to the surface of matrix metal particles 110, having a thermal conductivity of 35.0 W/K·m or less, and having an average particle size of 100 nm or more and 300 nm or less.

When the thermal conductivity is 35.0 W/K·m or less, low thermal conductivity particles 120 do not conduct heat readily. This reduces heat diffusion between adjacent matrix metal particles 110, thus resulting in an increase in building speed and an improvement in the precision of the three-dimensional object produced. In order to further increase the building speed and further improve the precision of the three-dimensional object produced, the thermal conductivity of low thermal conductivity particles 120 is preferably 20 W/K·m or less, more preferably 10 W/K·m or less, and even more preferably 5 W/K·m or less. The lower limit of the thermal conductivity may be the thermal conductivity of a material that, when used as low thermal conductivity particles 120, does not significantly impede production of the three-dimensional object and does not significantly change the properties of the produced three-dimensional object. The thermal conductivity may be, for example, 1 W/K·m or more.

A known value of the thermal conductivity of the material forming low thermal conductivity particles 120 can be employed as the thermal conductivity of low thermal conductivity particles 120. The material of low thermal conductivity particles 120 can be identified by a known method such as fluorescent X-ray analysis. Alternatively, the material of low thermal conductivity particles 120 may be identified by separating matrix metal particles 110 and low thermal conductivity particles 120 from each other with a known method such as ultrasonication in a surfactant-containing aqueous solution and then subjecting resultant low thermal conductivity particles 120 to fluorescent X-ray analysis or ICP optical emission spectroscopy.

Examples of materials having a thermal conductivity of 35.0 W/K·m or less include: metal oxides such as silicon oxide, titanium oxide, aluminum oxide, zinc oxide, zirconium oxide, cerium oxide, tungsten oxide, antimony oxide, copper oxide, tellurium oxide, and manganese oxide; barium titanate; strontium titanate; magnesium titanate; silicon nitride; boron nitride; and carbon nitride. In order to increase the strength of electrostatic charge-mediated attachment to the matrix metal particles, it is preferable for low thermal conductivity particles 120 to contain as a main component a metal oxide among the above materials, and it is more preferable for low thermal conductivity particles 120 to contain silicon oxide or aluminum oxide as a main component.

When the average particle size of low thermal conductivity particles 120 is 100 nm or more, a sufficient distance is provided between adjacent matrix metal particles 110 in formation of a thin layer of the powder material, and thus thermal conduction between adjacent matrix metal particles 110 is sufficiently reduced. This results in an increase in building speed and an improvement in the precision of the three-dimensional object produced. When the average particle size of low thermal conductivity particles 120 is 300 nm or less, adjacent matrix metal particles 110 are not excessively distant from each other, and thus matrix metal particles 110 can be sufficiently sintered or fused together to increase the mechanical strength of the three-dimensional object produced.

The average particle size of low thermal conductivity particles 120 can be determined as an average of particle sizes of 20 low thermal conductivity particles 120 (the particle size of each particle is an average of the longest and shortest diameters) which are randomly selected in a cross-sectional view of composite particles 100 as observed with a transmission electron microscope (TEM). It is preferable that the average particle size be calculated for 20 randomly selected composite particles 100 and an average of the calculated values be defined as the average particle size of low thermal conductivity particles 120 in the powder material. The average particle size of low thermal conductivity particles 120 may be a number-average particle size determined by separating matrix metal particles 110 and low thermal conductivity particles 120 from each other with a known method such as ultrasonication in a surfactant-containing aqueous solution, then subjecting resultant low thermal conductivity particles 120 to measurement with a laser diffraction/scattering particle size distribution analyzer (such as Partica LA-960 available from HORIBA, Ltd.), and making a calculation based on the measurement values on the assumption that the particles are spherical.

In order to uniformize the thermal conduction properties among composite particles 100, increase the building speed, and improve the precision of the three-dimensional object produced, the coefficient of variation (CV value) of the particle size distribution of low thermal conductivity particles 120 is preferably 15% or less. In order to further increase the building speed and further improve the precision of the three-dimensional object produced, the CV value of low thermal conductivity particles 120 is more preferably 10% or less and still more preferably 8% or less.

The CV value is determined as follows: particle sizes of 20 low thermal conductivity particles 120 (the particle size of each particle is an average of the longest and shortest diameters) which are randomly selected in a cross-sectional view of composite particles 100 as observed with a transmission electron microscope (TEM) are measured, the standard deviation σ and average particle size D are calculated for the measured particles sizes, and the CV value is calculated as (σ/D)×100. The standard deviation σ and average particle size D of low thermal conductivity particles 120 may be values determined by separating matrix metal particles 110 and low thermal conductivity particles 120 from each other with a known method such as ultrasonication in a surfactant-containing aqueous solution, then subjecting resultant matrix metal particles 110 to measurement with a laser diffraction/scattering particle size distribution analyzer (such as Partica LA-960 available from HORIBA, Ltd.), and making a calculation based on the measurement values on the assumption that the particles are spherical.

1-1-3. Combination of Matrix Metal Particles 110 and Low Thermal Conductivity Particles 120

The thermal conductivity of low thermal conductivity particles 120 is lower than the thermal conductivity of the metal material contained as a main component in matrix metal particles 110. With this feature, it is expected that heat diffusion between the adjacent matrix metal particles is reduced in a thin layer of the powder material according to the present embodiment and hence that the use of the powder material according to the present embodiment yields an increased building speed and at the same time an improved precision of the three-dimensional object produced.

In order to increase the building speed and improve the precision of the three-dimensional object produced, the difference between the thermal conductivity of matrix metal particles 110 and the thermal conductivity of low thermal conductivity particles 120 is preferably 100 W/K·m or more, more preferably 200 W/K·m or more, and even more preferably 300 W/K·m or more. The upper limit of the difference between the thermal conductivity of matrix metal particles 110 and the thermal conductivity of low thermal conductivity particles 120 is not particularly defined as long as a combination of materials usable for production of the three-dimensional object is possible. The upper limit of the difference may be, for example, 400 W/K·m.

The ratio (B/A) of the average particle size (B) of low thermal conductivity particles 120 to the average particle size (A) of matrix metal particles 110 is preferably 0.005 or more, more preferably 0.0075 or more, and even more preferably 0.01 or more. With this feature, it is expected that low thermal conductivity particles 120 interposed between adjacent matrix metal particles 110 ensure an appropriate distance between matrix metal particles 110 to reduce heat diffusion between matrix metal particles 110 and hence that an increased building speed and an improved precision of the three-dimensional object produced are achieved. The upper limit of the ratio B/A is not particularly defined as long as matrix metal particles 110 can be sintered or fused together by laser irradiation. The ratio B/A may be, for example, 0.015 or less.

The degree of coverage of the surface of each matrix metal particle 110 by low thermal conductivity particles 120 is preferably 5% or more and 50% or less, more preferably 10% or more and 40% or less, and even more preferably 20% or more and 30% or less. With this feature, it is expected that the amount of low thermal conductivity particles 120 which may remain as an impurity can be reduced and hence that the change in properties of the three-dimensional object is further reduced. The degree of coverage can be determined by taking an image of composite particles 100 with a scanning electron microscope (SEM) or a transmission electron microscope (TEM), using an image analyzer (such as Luzex 3 available from NIRECO CORPORATION) to measure the surface areas of matrix metal particles 110 and low thermal conductivity particles 120 constituting one composite particle 100 selected in the image, and dividing the surface area of low thermal conductivity particles 120 by the surface area of matrix metal particle 110. It is preferable that the degree of coverage be determined for 300 randomly selected composite particles 100 and an average of the determined values be calculated as the degree of coverage of the composite particles in the powder material.

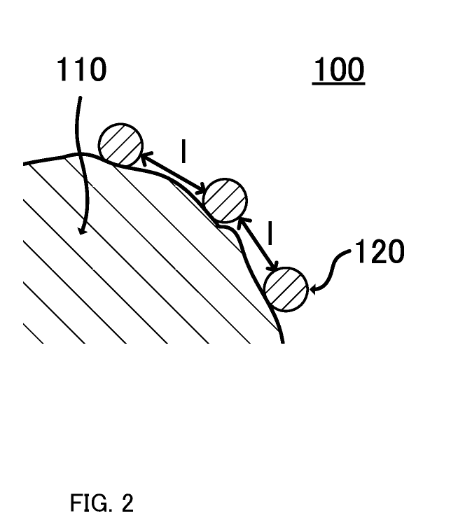

The ratio (L/A) of an average (L) of distances (l) between adjacent low thermal conductivity particles 120 on the surface of each matrix metal particle 110 to the average particle size (A) of matrix metal particles 110 is preferably 0.10 or less, more preferably 0.05 or less, and even more preferably 0.02 or less. With this feature, it is expected that the amount of low thermal conductivity particles 120 which may remain as an impurity can be reduced and hence that the change in properties of the three-dimensional object is further reduced. The lower limit of the ratio L/A is not particularly defined as long as the effect of the present embodiment on increase in building speed and improvement in the precision of the three-dimensional object produced can be obtained. The ratio L/A may be, for example, 0.005 or more. As shown in FIG. 2 which is a schematic partially-enlarged cross-sectional view of composite particle 100, the distance (l) between adjacent low thermal conductivity particles 120 refers to the shortest distance among distances between two points respectively set on the surfaces of adjacent low thermal conductivity particles 120. The distance l may be a value obtained by measurement based on the above SEM image or IBM image.

Low thermal conductivity particles 120 may be adhered to the surface of matrix metal particles 110 by a binder.

The material forming the binder may be any material having adhesion to matrix metal particles 110 and low thermal conductivity particles 120. In order to facilitate production of composite particles 100 by the method described later, the material is preferably a resin easily soluble in water or a solvent. Examples of the material forming the binder include polyvinyl alcohol (PVA), polyvinyl butyral (PVB), and acrylic resin.

1-1-4. Method of Producing Composite Particles 100

Composite particle 100 can be produced by attaching a plurality of low thermal conductivity particles 120 to the surface of matrix metal particle 110. Specifically, composite particles 100 can be produced by the steps of: (1-1) providing matrix metal particles 110 and low thermal conductivity particles 120; and (1-2) attaching a plurality of low thermal conductivity particles 120 to the surface of each matrix metal particle 110. When composite particles 100 have the binder, step (1-1) may include further providing the binder.

1-1-4-1. Step of Providing Matrix Metal Particles 110 and Low Thermal Conductivity Particles 120 (Step (1-1))

In this step, there are provided: matrix metal particles having an average particle size of 20 μm or more and 60 μm or less; and low thermal conductivity particles having an average particle size of 100 nm or more and 300 nm or less and a thermal conductivity of 35.0 W/K·m or less, the thermal conductivity being lower than the thermal conductivity of the metal forming the matrix metal particles.

In order to increase the building speed of the composite particles 100 to be produced and improve the precision of the three-dimensional object to be produced, a combination of the matrix metal particles and low thermal conductivity particles can be selected so that the ratio (B/A) of the average particle size (B) of the low thermal conductivity particles to the average particle size (A) of the matrix metal particles is 0.005 or more, preferably 0.0075 or more, and more preferably 0.010 or more. As for the upper limit of the ratio B/A, the ratio B/A may be, for example, 0.015 or less.

In order to uniformize the thermal conduction properties among composite particles 100, increase the building speed, and improve the precision of the three-dimensional object produced, the matrix metal particles and low thermal conductivity particles preferably have a particle size distribution with a coefficient of variation (CV value) of 15% or less. In order to further increase the building speed and further improve the precision of the three-dimensional object produced, the CV value of the matrix metal particles and low thermal conductivity particles is more preferably 10% or less and even more preferably 8% or less.

As long as the above requirements are satisfied, the matrix metal particles and low thermal conductivity particles may be commercially-sold products or may be fabricated by a known method such as atomization. Alternatively, particles fabricated by granulation may be classified through a known sieving device such as a membrane filter, and the classified particles may be used.

In order to increase the building speed of the composite particles 100 to be produced and improve the precision of the three-dimensional object to be produced, the ratio between the amounts of the matrix metal particles and low thermal conductivity particles can be set so that, in composite particles 100 produced, the degree of coverage of the surface of each matrix metal particle 110 by low thermal conductivity particles 120 will be 5% or more and 50% or less, preferably 10% or more and 40% or less, and more preferably 20% or more and 30% or less.

In order to increase the building speed the composite particles 100 to be produced and improve the precision of the three-dimensional object to be produced, the ratio between the amounts of the matrix metal particles and low thermal conductivity particles may be set so that, in composite particles 100 produced, the ratio (L/A) of the average (L) of distances between adjacent low thermal conductivity particles 120 on the surface of each matrix metal particle 110 to the average particle size (A) of matrix metal particles 110 will be 0.10 or less, preferably 0.05 or less, and more preferably 0.02 or less. In order to avoid an excessively high degree of coverage of the matrix metal particles by the low thermal conductivity particles, it is desirable to set the lower limit of the ratio L/A to 0.005, preferably to 0.01.

The amounts of matrix metal particles 110 and low thermal conductivity particles 120 may be such that low thermal conductivity particles 120 can be attached in the form of islands to the surface of each matrix metal particle 110. The term “attached in the form of islands” as used herein means that the low thermal conductivity particles are attached to the surface of the matrix metal particle and are spaced apart from each other on the surface of the matrix metal particle. In order for low thermal conductivity particles 120 to be attached in the form of islands, for example, the amount of low thermal conductivity particles 120 is preferably 0.01 mass % or more and 2 mass % or less with respect to the total mass of matrix metal particles 110 used. In order to achieve the ratio B/A, degree of coverage, or ratio L/A as described above, the amount of low thermal conductivity particles 120 is more preferably 0.1 mass % or more and 1 mass % or less and even more preferably 0.15 mass % or more and 0.5 mass % or less.

1-1-4-2. Step of Attaching Plurality of Low Thermal Conductivity Particles 120 to Surface of Matrix Metal Particle 110 (Step (1-2))

In this step, a plurality of low thermal conductivity particles 120 are attached to the surface of matrix metal particle 110. This step can be carried out by a known method used to attach other particles to the surface of a metal particle. For example, this step can be carried out by a wet coating process using a coating solution in which low thermal conductivity particles 120 are dissolved, by a dry coating process in which matrix metal particles 110 and low thermal conductivity particles 120 are stirred and bonded together by mechanical impact, or by a combination of the wet and dry coating processes. When the wet coating process is used, the surface of matrix metal particles 110 may be spray-coated with the coating solution, or matrix metal particles 110 may be immersed in the coating solution. When composite particles 100 to be produced have the binder, the binder may be dissolved in the coating solution used for the wet coating process or may be mixed into the particles during the stirring and mixing of the particles in the dry coating process. Of these processes, the dry coating process is preferred because this process can avoid the use of any coating solution and thus does not need to involve any solvent removal step so that the procedures can be simplified.

The dry coating process can be, for example, a process in which matrix metal particles 110 and low thermal conductivity particles 120 (and optionally the binder used as appropriate) are stirred and homogeneously mixed using a common stirring device (this step may be simply referred to as “first stirring” hereinafter) and then the resulting mixture is further stirred and mixed using a common rotary blade-type stirring device for 5 minutes or more and 40 minutes or less (this step may be simply referred to as “second stirring”). When the binder is stirred and mixed together with the particles, it is preferable to perform the first stirring at ordinary temperature for 5 minutes or more and 15 minutes or less and then perform the second stirring in a temperature range from a temperature 15° C. below the glass transition temperature (Tg) of the binder to a temperature 15° C. above the glass transition temperature.

1-2. Other Materials

1-2-1. Laser Absorber

In order to more efficiently convert optical energy of a laser to thermal energy, the powder material may further include a laser absorber. The laser absorber may be any material that absorbs laser of the used wavelength to generate heat. Examples of such a laser absorber include a carbon powder, a nylon resin powder, a pigment, and a dye. One of these laser absorbers may be used alone or two of these laser absorbers may be used in combination.

The amount of the laser absorber can be set as appropriate so that the melting and bonding of composite particles 100 will be easy. For example, the amount of the laser absorber can be more than 0 mass % and less than 3 mass % with respect to the total mass of the powder material.

1-2-2. Flow Agent

In order to improve the flowability of the powder material and allow easy handling of the powder material in production of the three-dimensional object, the powder material may further include a flow agent. The flow agent may be any material that has a low friction coefficient and is self-lubricating. Examples of such a flow agent include silicon dioxide and boron nitride. One of these flow agents may be used alone or two of these flow agents may be used in combination. Even when the powder material has an increased flowability due to the flow agent, composite particles 100 are unlikely to become electrically charged and can be more densely spread to form a thin layer.

The amount of the flow agent can be set as appropriate as long as the flowability of the powder material is improved while sufficient fusion of composite particles 100 is accomplished. For example, the amount of the flow agent can be more than 0.0 mass % and less than 2.0 mass % with respect to the total mass of the powder material.

1-3. Method of Producing Powder Material

Composite particles 100 can be used by themselves as the powder material. When the powder material further includes the other materials described above, the other materials in the form of powder and composite particles 100 can be stirred and mixed together to obtain the powder material.

2. Method of Producing Three-Dimensional Object

The present embodiment relates to a method of producing a three-dimensional object using the powder material. The method according to the present embodiment can be carried out in the same manner as a common powder bed fusion process, except that the powder material including composite particles 100 is used. Specifically, the method according to the present embodiment includes the steps of: (2-1) forming a thin layer of the powder material; (2-2) selectively irradiating the formed thin layer with a laser beam to sinter or fuse composite particles 100 contained in the powder material and form an object layer composed of sintered or fused composite particles 100; and (2-3) repeating steps (2-1) and (2-2) in the order mentioned to stack the object layers on top of one another. In step (2-2), one of the object layers constituting the three-dimensional object is formed. In step (2-3), steps (2-1) and (2-2) are repeated to stack layers of the three-dimensional object one after another and finally produce the three-dimensional object.

2-1. Step of Forming Thin Layer of Powder Material (Step (2-1))

In this step, a thin layer of the powder material is formed. For example, the powder material fed from a powder feed section is flatly spread over a build stage by means of a recoater. The thin layer may be formed directly on or above the build stage or may be formed in contact with the powder material previously spread or an object layer previously formed.

The thickness of the thin layer is equal to the thickness of the object layer. The thickness of the thin layer can be set as appropriate according to, for example, the shape of the three-dimensional object to be produced and is typically 0.05 mm or more and 1.0 mm or less. When the thickness of the thin layer is 0.05 mm or more, the particles in a lower object layer can be prevented from being sintered or fused by laser irradiation for formation of an upper object layer. When the thickness of the thin layer is 1.0 mm or less, laser can be transmitted to the bottom of the thin layer, so that the composite particles contained in the powder material forming the thin layer can be sufficiently sintered or fused over the entire thickness of the thin layer. From these points of view, the thickness of the thin layer is more preferably 0.05 mm or more and 0.50 mm or less, even more preferably 0.05 mm or more and 0.30 mm or less, and still even more preferably 0.05 mm or more and 0.10 mm or less. In order to more sufficiently sinter or fuse the composite particles over the entire thickness of the thin layer and reduce the occurrence of cracking of the stacked layers, the thickness of the thin layer is preferably set so that the difference between the thickness and the laser beam spot size described later is 0.10 mm or less.

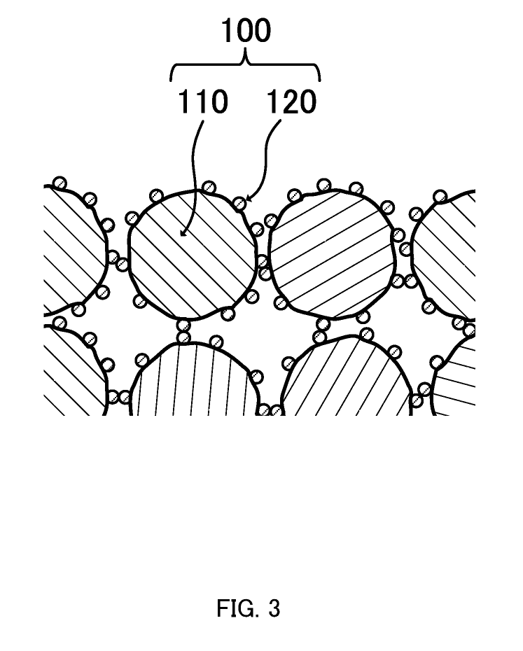

FIG. 3 is a schematic cross-sectional view of the thin layer formed as described above. In this thin layer, low thermal conductivity particles 120 as a component of composite particles 100 are present between matrix metal particles 110, and thus matrix metal particles 110 are not in contact with each other but are spaced apart at appropriate distances with low thermal conductivity particles 120 interposed therebetween. As previously described, low thermal conductivity particles 120 do not conduct heat of matrix metal particles 110 generated by the below-described preheating or laser irradiation to the outside of composite particles 100, and the heat is retained in matrix metal particles 110. These factors are expected to reduce heat diffusion between adjacent matrix metal particles 110 in the thin layer, so that the use of the powder material including composite particles 100 in production of a three-dimensional object by powder bed fusion process yields an increased building speed and an improved precision of the three-dimensional object produced.

2-2. Step of Forming Object Layer Composed of Sintered or Fused Composite Particles 100 (Step (2-2))

In this step, a region of the formed thin layer of the powder material where an object layer should be formed is selectively irradiated with a laser to sinter or fuse composite particles 100 present in the irradiated region. As a result of sintering or fusing, composite particles 100 are merged together with adjacent powder to form a sintered body or fused body as an object layer. At this instant, composite particles 100 having received laser energy are sintered or fused with the metal material of a previously formed object layer, and thus the adjacent layers are adhered together.

The laser wavelength may be set freely as long as the metal material contained as a main component in matrix metal particles 110 can absorb the laser.

The laser output power may be set freely as long as the metal material forming composite particles 100 can be sufficiently sintered or fused when the laser scanning speed is as described below. Specifically, the laser output power can be 5.0 W or more and 1,000 W or less. With the powder material, even the use of a low-energy laser can easily induce sintering or fusion of composite particles 100 to produce the three-dimensional object regardless of the type of the metal material. In order to lower laser energy, reduce the production cost, and make the configuration of the production apparatus simple, the laser output power is preferably 500 W or less and more preferably 300 W or less.

The laser scanning speed may be set freely as long as increase in production cost and excessive complication of the apparatus configuration are avoided. To be specific, the laser scanning speed is preferably 5 mm/sec or more and 10,000 mm/sec or less, more preferably 100 mm/sec or more and 8,000 mm/sec or less, and even more preferably 2,000 mm/sec or more and 7,000 mm/sec or less.

The laser beam diameter can be set as appropriate according to, for example, the shape of the three-dimensional object to be produced.

2-3. Step of Preheating Formed Thin Layer of Powder Material (Step (3))

In this step, step (1) and step (2) are repeated to stack the object layers formed by step (2) on top of one another. A desired three-dimensional object is produced by stacking the object layers.

2-4. Other Details

In order to prevent the strength of the three-dimensional object from being low due to oxidation or nitridation of the metal material contained as a main component in matrix metal particles 110 during sintering or fusion, at least step (2-2) is preferably carried out at a reduced pressure or in an inert gas atmosphere. The reduced pressure is preferably 10⁻² Pa or less and more preferably 10⁻³ Pa or less. Examples of the inert gas that can be used in the present embodiment include nitrogen gas and noble gases. Among these inert gases, nitrogen (N₂) gas, helium (He) gas, or argon (Ar) gas is preferred in terms of availability. In order to simplify the production steps, both step (2-1) and step (2-2) are preferably carried out at a reduced pressure or in an inert gas atmosphere.

In order to facilitate sintering or fusion of the composite particles, the thin layer of the powder material may be preheated before step (2-2). For example, a temperature regulator such as a heater can be used to selectively heat the region where the object layer should be formed or to preliminarily heat the entire interior of the production apparatus so that the surface of the thin layer is adjusted to a temperature 15° C. below the melting point of the metal material, preferably to a temperature 5° C. below the melting point of the metal material.

In order to prevent the precision of the produced three-dimensional object from being low due to remelting of the formed object layer, a temperature regulator may be used to selectively cool the region where the object layer should be formed or to cool the entire interior of the production apparatus.

3. Three-Dimensional Shaping Apparatus

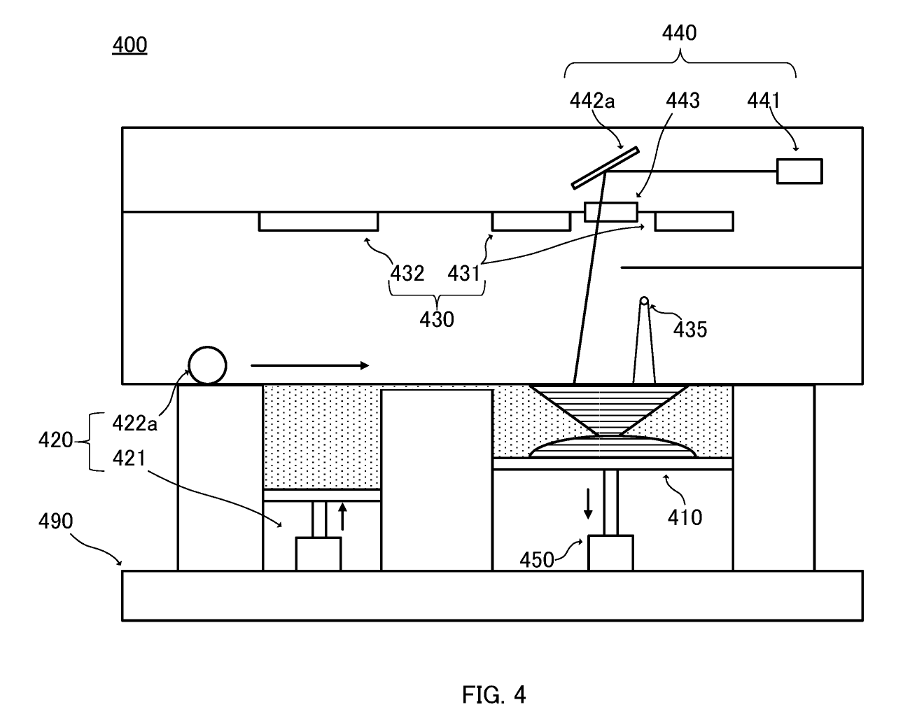

The present embodiment relates to an apparatus for producing a three-dimensional object using the powder material. The apparatus according to the present embodiment can be configured in the same manner as known apparatuses for producing three-dimensional objects by powder bed fusion process, except that the powder material is used. Specifically, three-dimensional shaping apparatus 400 according to the present embodiment includes, as shown in FIG. 4 which is a side view schematically illustrating the configuration of the apparatus: build stage 410 located within a cavity; thin layer formation section 420 that forms a thin layer of a powder material containing resin particles having a core-shell structure on or above the build stage; temperature regulation section 430 that heats or cools the surface of the thin layer formed on or above the build stage or heats or cools the interior of the apparatus; laser irradiation section 440 that irradiates the thin layer with a laser to form an object layer composed of the resin particles fused together; stage support section 450 supporting build stage 410 and capable of changing the position of build stage 410 in the vertical direction; and base 490 supporting these sections.

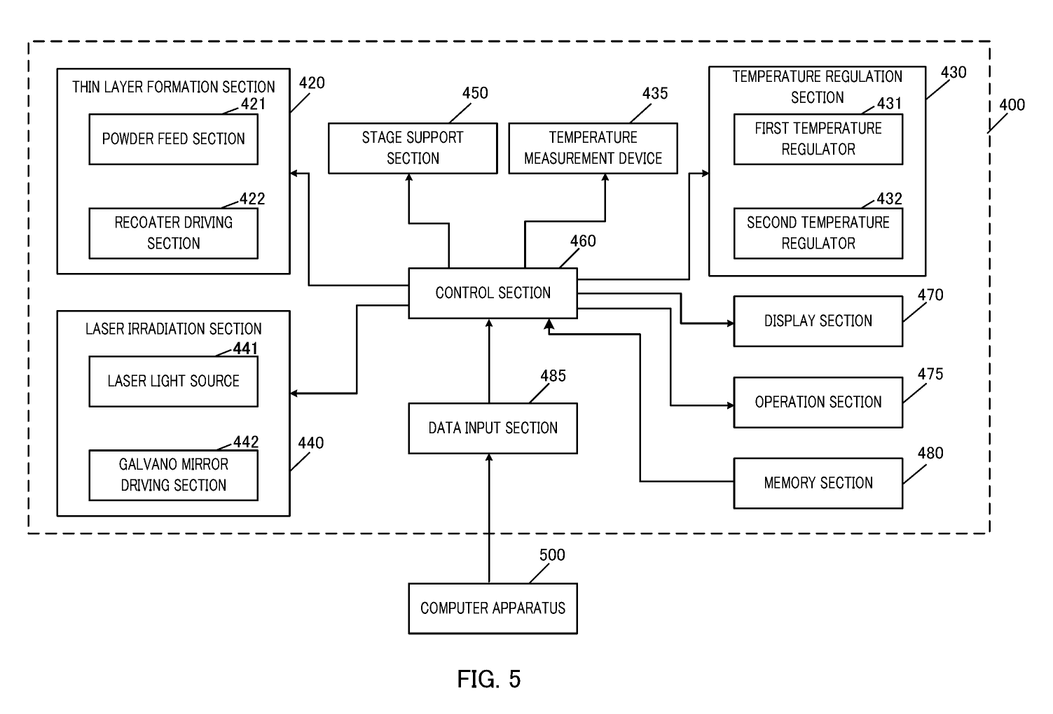

Three-dimensional shaping apparatus 400 may, as shown in FIG. 5 illustrating the main parts of the control system of the apparatus, include: control section 460 that controls thin layer formation section 420, temperature regulation section 430, laser irradiation section 440, and stage support section 450 to repeat formation of the object layer and stack the object layers on top of one another; display section 470 for displaying various information; operation section 475 including a pointing device for receiving instructions from the user; memory section 480 that stores various information including a control program executed by control section 460; and data input section 485 including an interface for transmitting and receiving various information such as three-dimensional shaping data to and from external devices. Additionally, the three-dimensional shaping apparatus may include temperature measurement device 435 that measures the temperature of a region of the thin layer formed on or above the build stage 410, the region being that where the object layer should be formed. Computer apparatus 500 for generating data for three-dimensional shaping may be connected to three-dimensional shaping apparatus 400.

On build stage 410, an object layer is formed through formation of a thin layer by thin layer formation section 420, temperature regulation by temperature regulation section 430, and laser irradiation by laser irradiation section 440, and the object layers are stacked on top of one another to build a three-dimensional object.

Thin layer formation section 420 can be configured to include: powder feed section 421 including a cavity having an opening edge lying in approximately the same horizontal plane as the opening edge of the cavity in which build stage 410 is elevated and lowered, a powder material reservoir section extending below the opening edge of the cavity in the vertical direction, and a feeding piston that is provided at the bottom of the powder material reservoir section and that is elevated and lowered in the cavity; and recoater 422a that spreads the fed powder material flatly over build stage 410 to form a thin layer of the powder material.

Powder feed section 421 may include a powder material reservoir section provided at a position higher than build stage 410 in the vertical direction and a nozzle and may be configured to discharge the powder material onto the horizontal plane in which the build stage lies.

It is sufficient for temperature regulation section 430 to be capable of heating the region of the surface of the thin layer where the object layer should be formed or cooling the surface of the formed object layer and maintaining the temperature of the heated region or cooled surface. For example, temperature regulation section 430 may be configured to include first temperature regulator 431 capable of heating or cooling the surface of the thin layer formed on build stage 410 and may be configured to include second temperature regulator 432 that heats the powder material before the powder material is fed onto the build stage. Temperature regulation section 430 may be configured to selectively heat the region where the object layer should be formed or may be configured to preliminarily heat the entire interior of the apparatus and regulating the temperature of the surface of the formed thin layer to a predetermined temperature.

It is sufficient for temperature measurement device 435 to be capable of non-contact measurement of the surface temperature of the region where the object layer should be formed, and temperature measurement device 435 can be, for example, an infrared sensor or optical pyrometer.

Laser irradiation section 440 includes laser light source 441 and galvano mirror 442a. Laser irradiation section 440 may include laser window 443 through which a laser passes and a lens (not shown) for adjusting the focus of the laser to the surface of the thin layer. Laser light source 441 may be any light source that emits a laser of the wavelength described above at the output power described above. Examples of laser light source 441 include a YAG laser light source, a fiber laser light source, and a CO₂ laser light source. Galvano mirror 442a may be constituted by an X mirror that reflects the laser emitted from laser light source 441 and scans the laser in the X direction and a Y mirror that reflects the laser emitted from laser light source 441 and scans the laser in the Y direction. Laser window 443 may be made of any material transparent to the laser.

Stage support section 450 supports build stage 410 and is capable of changing the position of build stage 410 in the vertical direction. That is, build stage 410 is configured to be finely movable by stage support section 450 in the vertical direction. Stage support section 450 can be configured in various manners and may, for example, be constituted by a holding member that holds build stage 410, a guide member that guides the holding member in the vertical direction, and a ball screw engaged with a screw hole provided in the guide member.

Control section 460 includes a hardware processor such as a central processing unit and controls the operations of entire three-dimensional shaping apparatus 400 during the building of a three-dimensional object.

Control section 460 may be configured, for example, to convert three-dimensional shaping data acquired by data input section 485 from computer apparatus 500 to a plurality of slice data each representing one of slices into which the three-dimensional shaping data is divided in the direction of stacking of the object layers. Slice data are shaping data for forming the object layers to build a three-dimensional object. The thickness of each slice data, namely the thickness of each object layer, is equal to the distance (stacking pitch) corresponding to the thickness of one object layer.

Display section 470 can be embodied, for example, by a liquid crystal display or an organic EL display.

Operation section 475 can be configured to include pointing devices such as a keyboard and a mouse and may include various operational keys such as numeric keys, an enter key, and a start key.

Memory section 480 can be configured to include various recording media such as a ROM, a RAM, a magnetic disk, an HDD, and an SSD.

Three-dimensional shaping apparatus 400 may include a pressure reducer (not shown) such as a pressure-reducing pump that reduces the pressure inside the apparatus under control by control section 460 or may include an inert gas feeder (not shown) that feeds an inert gas into the apparatus under control by control section 460.

3-1. Three-Dimensional Shaping Using Three-Dimensional Shaping Apparatus 400

Control section 460 converts three-dimensional shaping data acquired by data input section 485 from computer apparatus 500 to a plurality of slice data each representing one of slices into which the three-dimensional shaping data is divided in the direction of stacking of the object layers. After that, control section 460 controls the following operations in three-dimensional shaping apparatus 400.

Powder feed section 421 drives a motor and a driving mechanism (both of which are not shown) according to feeding information output from control section 460, and moves the feeding piston upwardly in the vertical direction (the direction indicated by the arrow in the figure) to push out the powder material onto the horizontal plane in which the build stage lies.

After that, recoater driving section 422 moves recoater 422a in the horizontal direction (the direction indicated by the arrow in the figure) according to thin layer formation information output from control section 460 to carry the powder material to build stage 410 and press the powder material into a thin layer having a thickness corresponding to the thickness of one object layer.

Temperature regulation section 430 heats the surface of the formed thin layer or the entire interior of the apparatus according to temperature information output from control section 460. The temperature information can be information according to which the surface of the thin layer is heated to a temperature differing by 5° C. or more and 50° C. or less from a temperature (Tmc) at which the material forming the core resin melts. Data of temperature Tmc is input through data input section 485, and the temperature to which the surface of the thin layer is heated is retrieved by control section 460 from memory section 480 on the basis of the data of temperature Tmc. Temperature regulation section 430 may start the heating after formation of the thin layer or may, before formation of the thin layer, start to heat an area corresponding to the surface of the thin layer to be formed or heat the interior of the apparatus.

Subsequently, laser irradiation section 440 causes, according to laser irradiation information output from control section 460, laser light source 441 to emit a laser and galvano mirror driving section 442 to drive galvano mirror 442a to scan the laser in correspondence with the region of the thin layer that constitutes a part of the three-dimensional object in the corresponding slice data. The laser irradiation induces fusion of the resin particles included in the powder material, thus resulting in formation of an object layer.

Subsequently, stage support section 450 drives a motor and a driving mechanism (both of which are not shown) according to position control information output from control section 460 to move build stage 410 downwardly in the vertical direction (the direction indicated by the arrow in the figure) by a distance corresponding to the stacking pitch.

Display section 470 operates under control by control section 460 to display, if necessary, various information that should be held by the user or messages. Operation section 475 receives various input operations made by the user and outputs operational signals depending on the input operations to control section 460. For example, a virtual image of the three-dimensional object to be formed may be displayed on display section 470 to check whether a desired shape will be obtained and, if it has been determined that the desired shape will not be obtained, a correction may be made through operation section 475.

Control section 460 stores data into memory section 480 or retrieve data from memory section 480 according to need.

Control section 460 may receive, from temperature measurement device 435, information on the temperature of the region of the surface of the thin layer where the object layer should be formed, and may control heating by temperature regulation section 430 so that the temperature of the region where the object layer should be formed will be higher by 5° C. or more and 50° C. or less, preferably by 5° C. or more and 25° C. or less, than the temperature (Tmc) at which the material forming the core resin melts.

The above operations are repeated to stack object layers on top of one another and thereby produce a three-dimensional object.

### EXAMPLES

Hereinafter, specific examples of the present invention will be described. These examples are not intended to limit the scope of the present invention.

1. Production of Powder Materials

Powder materials 1 to 18 were produced by the method described below using the materials described below. The average particle sizes of the particles are number-average particle sizes calculated from measurement values of measurement with a laser diffraction/scattering particle size distribution analyzer (Partica LA-960 available from HORIBA, Ltd.) on the assumption that the particles were spherical. The CV values of the particles are those obtained by determining the standard deviation σ and number-average particle size D for the particle size distribution measured with the laser diffraction/scattering particle size distribution analyzer and calculating (σ/D)×100 from the standard deviation σ and average particle size D. The average particle sizes and CV values of the particles were adjusted to desired values by classification with several types of membrane filters.

The values of the thermal conductivity of the materials are those measured using a thermal conductivity measurement apparatus (TCi Thermal Conductivity Analyzer available from C-Therm Technologies Ltd.). The thermal conductivity of silicon oxide was 1.20 W/K·m, the thermal conductivity of silicon nitride was 27.0 W/K·m, the thermal conductivity of aluminum oxide was 30.1 W/K·m, the thermal conductivity of silicon carbide was 270 W/K·m, and the thermal conductivity of boron nitride was 40.0 W/K·m.

1-1. Powder Material 1

100 parts by weight of copper particles (available from Hikari Material Industry Co., Ltd. under the product name “Copper Powder”, average particle size: 40 μm, CV value: 10%) and 0.24 parts by weight of silicon oxide particles (available from Cabot Corporation under the product name “CAB-O-SIL”, average particle size: 200 nm, CV value: 10%) were placed in a Henschel mixer (available from Nippon Coke & Engineering Co., Ltd., Model: FM20C/I) and stirred for 20 minutes at a rotation speed set so that the blade peripheral speed was 40 m/s. Thus, powder material 1 including composite particles composed of the copper particles with the silicon oxide particles attached thereto was obtained. During mixing, cooling water was poured into a bath surrounding the Henschel mixer at a flow rate of 5 L/min to control the temperature to 40° C.±1° C.

1-2. Powder Material 2

Powder material 2 was obtained in the same manner as powder material 1, except that the silicon oxide particles were replaced by 0.14 parts by weight of silicon oxide particles having a different average particle size (available from Cabot Corporation under the product name “CAB-O-SIL”, average particle size: 120 nm, CV value: 10%).

1-3. Powder Material 3

Powder material 3 was obtained in the same manner as powder material 1, except that the copper particles were replaced by other copper particles (available from Hikari Material Industry Co., Ltd. under the product name “Copper Powder”, average particle size: 40 μm, CV value: 20%).

1-4. Powder Material 4

Powder material 4 was obtained in the same manner as powder material 1, except that the silicon oxide particles were replaced by silicon oxide particles having a different CV value (available from Cabot Corporation under the product name “CAB-O-SIL”, average particle size: 200 nm, CV value: 20%).

1-5. Powder Material 5

Powder material 5 was obtained in the same manner as powder material 1, except that the silicon oxide particles were replaced by 0.31 parts by weight of silicon nitride (Si₃N₄) particles (available from Denka Company Limited under the product name “SN-9FWS”, average particle size: 200 nm, CV value: 10%).

1-6. Powder Material 6

Powder material 6 was obtained in the same manner as powder material 1, except that the amount of the silicon oxide particles was 0.024 parts by weight.

1-7. Powder Material 7

Powder material 7 was obtained in the same manner as powder material 1, except that the amount of the silicon oxide particles was 0.35 parts by weight.

1-8. Powder Material 8

Powder material 5 was obtained in the same manner as powder material 1, except that the amount of the silicon oxide particles was 0.03 parts by weight.

1-9. Powder Material 9

Powder material 9 was obtained in the same manner as powder material 1, except that the amount of the copper particles was 50 parts by weight.

1-10. Powder Material 10

Powder material 10 was obtained in the same manner as powder material 1, except that the silicon oxide particles were replaced by 0.36 parts by weight of aluminum oxide particles (available from Denka Company Limited under the product name “ASFP-20”, average particle size: 200 nm, CV value: 10%).

1-11. Powder Material 11

Powder material 11 was obtained in the same manner as powder material 5, except that the copper particles were replaced by 35 parts by weight of aluminum particles (available from Hikari Material Industry Co., Ltd. under the product name “Pure Al”, average particle size: 40 μm, CV value: 10%) and that the CV value of the silicon oxide particles was adjusted to 15%.

1-12. Powder Material 12

Powder material 12 was obtained in the same manner as powder material 1, except that the copper particles were replaced by 35 parts by weight of aluminum particles (available from Hikari Material Industry Co., Ltd. under the product name “Pure Al”, average particle size: 40 μm, CV value: 10%).

1-13. Powder Material 13

Copper particles (available from Hikari Material Industry Co., Ltd. under the product name “Copper Powder”, average particle size: 50 μm, CV value: 10%) were used by themselves as powder material 13.

1-14. Powder Material 14

Powder material 14 was obtained in the same manner as powder material 1, except that the silicon oxide particles were replaced by 0.47 parts by weight of silicon oxide particles having a different average particle size (available from Cabot Corporation under the product name “CAB -0-SIL”, average particle size: 400 nm, CV value: 10%).

1-15. Powder Material 15

Powder material 15 was obtained in the same manner as powder material 1, except that the silicon oxide particles were replaced by 0.19 parts by weight of silicon carbide particles (available from Shin-Etsu Chemicals Co.,

Ltd. under the product name “SEA-66”, average particle size: 200 nm, CV value: 10%).

1-16. Powder Material 16

Powder material 16 was obtained in the same manner as powder material 1, except that the silicon oxide particles were replaced by 0.19 parts by weight of boron nitride (BN) particles (available from ESK Ceramics GmbH & Co. KG under the product name “SCP-1”, average particle size: 200 nm, CV value: 10%).

1-17. Powder Material 17

Powder material 17 was obtained in the same manner as powder material 1, except that the copper particles were replaced by 0.94 parts by weight of copper particles having a different average particle size (available from Mitsui Mining & Smelting Co., Ltd. under the product name “MA-005-2”, average particle size: 10 μm, CV value: 40%).

1-18. Powder Material 18

Powder material 18 was obtained by mixing 100 parts by weight of copper particles (available from Hikari Material Industry Co., Ltd. under the product name “Copper Powder”, average particle size: 40 μm, CV value: 10%) and 0.1 parts by weight of copper particles (available from SkySpring Nanomaterials, Inc. under the product name “08005J”, average particle size: 25 nm, CV value: 10%).

Table 1 shows the main component, average particle size (A), CV value, thermal conductivity, and amount of the matrix metal particles used for production of powder materials 1 to 18 and the main component, average particle size (B), CV value, thermal conductivity, and amount of the low thermal conductivity particles used for production of powder materials 1 to 18.

TABLE 1
Materials of Composite Particles 1 to 18

| | Matrix metal particles | | | | | Low thermal conductivity particles | | | | |
|---|---|---|---|---|---|---|---|---|---|---|
| Powder | | Average | | Thermal | Amount | | Average | | Thermal | Amount |
| material | Main | particle size | CV value | conductivity | (parts by | Main | particle size | CV value | conductivity | (parts by |
| No. | component | (A) [μm] | [%] | [W/K · m] | weight) | component | (B) [nm] | [%] | [W/K · m] | weight) |
| 1 | Cu | 40 | 10 | 395 | 100 | SiO₂ | 200 | 10 | 1.20 | 0.24 |
| 2 | Cu | 40 | 10 | 395 | 100 | SiO₂ | 120 | 10 | 1.20 | 0.14 |
| 3 | Cu | 40 | 20 | 395 | 100 | SiO₂ | 200 | 10 | 1.20 | 0.24 |
| 4 | Cu | 40 | 10 | 395 | 100 | SiO₂ | 200 | 20 | 1.20 | 0.24 |
| 5 | Cu | 40 | 10 | 395 | 100 | Si₃N₄ | 200 | 10 | 27 | 0.31 |
| 6 | Cu | 40 | 10 | 395 | 100 | SiO₂ | 200 | 10 | 1.20 | 0.024 |
| 7 | Cu | 40 | 10 | 395 | 100 | SiO₂ | 200 | 10 | 1.20 | 0.35 |
| 8 | Cu | 40 | 10 | 395 | 100 | SiO₂ | 200 | 10 | 1.20 | 0.03 |
| 9 | Cu | 20 | 10 | 395 | 50 | SiO₂ | 200 | 10 | 1.20 | 0.24 |
| 10 | Cu | 40 | 10 | 395 | 100 | Al₂O₃ | 200 | 10 | 30.1 | 0.36 |
| 11 | Al | 40 | 10 | 240 | 35 | SiO₂ | 200 | 15 | 1.20 | 0.24 |
| 12 | Al | 40 | 10 | 240 | 35 | SiO₂ | 200 | 10 | 1.20 | 0.24 |
| 13 | Cu | 50 | 10 | 395 | 100 | — | — | — | — | — |
| 14 | Cu | 40 | 10 | 395 | 100 | SiO₂ | 400 | 10 | 1.20 | 0.47 |
| 15 | Cu | 40 | 10 | 395 | 100 | SiC | 200 | 10 | 270 | 0.19 |
| 16 | Cu | 40 | 10 | 395 | 100 | BN | 200 | 10 | 40.0 | 0.19 |
| 17 | Cu | 10 | 40 | 395 | 100 | SiO₂ | 200 | 10 | 1.20 | 0.94 |
| 18 | Cu | 40 | 10 | 395 | 100 | — | — | — | — | — |

*Powder material 18 is a mixture of copper particles having an average particle size of 40 μm and copper particles having an average particle size of 25 nm.

2. Measurement for Powder Materials

Powder materials 1 to 18 were individually observed with a scanning electron microscope (SEM), and the areas of the matrix metal particle and low thermal conductivity particles constituting a composite particle selected in the obtained SEM image were measured using an image analyzer (Luzex 3 available from NIRECO CORPORATION). The area of the low thermal conductivity particles was divided by the area of the matrix metal particle to determine the degree of coverage for the composite particle. The degree of coverage was determined for 300 randomly selected composite particles, and an average of the determined values was employed as the degree of coverage in the powder material.

For each of powder materials 1 to 18, the average particle size (A) of the matrix metal particles used for production of the powder material was divided by the average particle size (B) of the low thermal conductivity particles used for production of the powder material to determine the ratio B/A in the powder material.

Additionally, a SEM image of each powder material was obtained in the same manner as in the measurement of the degree of coverage, and the distance between the low thermal conductivity particles of a composite particle selected in the SEM image was measured at 20 sites to determine the distance between the adjacent low thermal conductivity particles in the composite particle. The distance between the adjacent low thermal conductivity particles was determined for 300 randomly selected composite particles, and an average of the determined values was employed as the distance (L) between the adjacent low thermal conductivity particles in the powder material. The average distance (L) between the adjacent low thermal conductivity particles was divided by the average particle size (A) of the matrix metal particles used for production of the powder material, and thus the ratio L/A was determined.

Table 2 shows the degree of coverage, the ratio B/A, the average distance (L) between the adjacent low thermal conductivity particles, and the ratio L/A for powder materials 1 to 18.

TABLE 2
Results of Measurement for Composite Particles 1 to 18

Composite particles

| | Degree of | | | |
|---|---|---|---|---|
| Powder material | coverage | | L | |
| No. | [%] | B/A | [μm] | L/A |
| 1 | 40 | 0.005 | 0.5 | 0.0125 |
| 2 | 40 | 0.003 | 0.5 | 0.0125 |
| 3 | 40 | 0.005 | 0.5 | 0.0125 |
| 4 | 40 | 0.005 | 0.5 | 0.0125 |
| 5 | 40 | 0.005 | 0.5 | 0.0125 |
| 6 | 4.0 | 0.005 | 4.0 | 0.1000 |
| 7 | 60 | 0.005 | 0.4 | 0.0100 |
| 8 | 5.0 | 0.005 | 4.4 | 0.1100 |
| 9 | 40 | 0.010 | 0.3 | 0.0150 |
| 10 | 40 | 0.005 | 0.5 | 0.0125 |
| 11 | 40 | 0.005 | 0.5 | 0.0125 |
| 12 | 40 | 0.005 | 0.5 | 0.0125 |
| 13 | — | — | — | — |
| 14 | 40 | 0.010 | 0.4 | 0.0100 |
| 15 | 40 | 0.005 | 0.5 | 0.0125 |
| 16 | 40 | 0.005 | 0.5 | 0.0125 |
| 17 | 40 | 0.005 | 0.5 | 0.0125 |
| 18 | — | — | — | — |

3. Evaluation

3-1. Building Speed

Each of powder materials 1 to 18 was spread to form a 1-mm-thick powder layer, which was irradiated with a laser at a wavelength of 1.07 μm, an output power of 250 W, a beam diameter on the surface of the powder layer of 30 μm, a scanning pitch of 40 μm, and a scanning speed of 1,000 mm/sec, 2,000 mm/sec, 3,000 mm/sec, or 4,000 mm/sec. Formation of an object layer in the shape of a 10 mm×10 mm square was thus attempted, and the resulting layer was used as a test specimen. The surface of the object thus obtained as a test specimen was observed with an optical microscope, and it was examined whether defects (void portions resulting from failure of object formation) larger than the matrix metal particles used for production of the powder material were present in the object. The fastest laser scanning speed among laser scanning speeds at which an object free of the defects was successfully produced was employed as the building speed for the powder material.

3-2. Dimensional Precision of Object

Each of powder materials 1 to 18 was spread to form a 1-mm-thick powder layer, which was irradiated with a laser at a wavelength of 1.07 μm, an output power of 250 W, a beam diameter on the surface of the powder layer of 30 μm, a scanning pitch of 40 μm, and a scanning speed of 2,000 mm/sec. Formation of an object layer in the shape of a 10 mm×10 mm square was thus attempted, and the resulting layer was used as a test specimen. The dimensions of this test specimen in the longitudinal and transverse directions were measured with a digital caliper (Super Caliper CD67-S PS/PM available from Mitutoyo Corporation; “Super Caliper” is the registered trademark of this corporation).

The differences between the intended dimensions and the measured dimensions were averaged, and the average was employed as a dimension error of the object. The value of the determined dimension error was rounded off to one decimal place, and the rounded-off value was employed as an index of the dimensional precision for the powder material.

The results of evaluation of powder materials 1 to 18 are shown in Table 3.

TABLE 3
Results of Evaluation of Powder Materials 1 to 18

| | | Dimensional Precision of |
|---|---|---|
| | Building speed | Object |
| Powder material No. | [mm/s] | [mm] |
| 1 | 4000 | 0.1 |
| 2 | 3000 | 0.2 |
| 3 | 3000 | 0.2 |
| 4 | 3000 | 0.2 |
| 5 | 3000 | 0.2 |
| 6 | 3000 | 0.2 |
| 7 | 3000 | 0.2 |
| 8 | 3000 | 0.2 |
| 9 | 3000 | 0.2 |
| 10 | 3000 | 0.2 |
| 11 | 3000 | 0.2 |
| 12 | 3000 | 0.2 |
| 13 | 1000 | 1.0 |
| 14 | 1000 | 2.0 |
| 15 | 1000 | 1.0 |
| 16 | 1000 | 1.0 |
| 17 | 1000 | 2.0 |
| 18 | 1000 | 1.0 |

With the use of any of powder materials 1 to 12, each including composite particles in which low thermal conductivity particles having a lower thermal conductivity than the metal material of matrix metal particles were attached in the form of islands to the surface of the matrix metal particles, in which the average particle size of the low thermal conductivity particles was 100 nm or more and 300 nm or less, and in which the thermal conductivity of the low thermal conductivity particles was 35.0 W/K·m or less, the building speed was successfully increased and, at the same time, the precision of the produced three-dimensional object was successfully improved.

In particular, a faster building speed and a higher precision of the produced three-dimensional object were achieved when the ratio (B/A) of the number-average particle size (B) of the low thermal conductivity particles to the number-average particle size (A) of the matrix metal particles was 0.005 or more (comparison of powder material 1 with powder material 2), when the CV value of the matrix metal particles was 15% or less (comparison of powder material 1 with powder material 3), when the CV value of the low thermal conductivity particles was 15% or less (comparison of powder material 1 with powder material 4), when the main component of the low thermal conductivity particles was an oxide (comparison of powder material 1 with powder material 5), when the degree of coverage by the low thermal conductivity particles was 5% or more and 50% or less (comparison of powder material 1 with powder material 6 and powder material 7), or when the ratio L/A was 0.10 or less (comparison of powder material 1 with powder material 8).

By contrast, with the use of powder material having no low thermal conductivity particles, neither the increase in building speed nor the improvement in precision of the produced three-dimensional object was achieved (powder material 13). This is presumably because heat diffused between the adjacent matrix metal particles, and thus the heat diffusion inhibited the temperature increase of the matrix metal particles and caused partial sintering or fusion of the matrix metal particles in a non-laser-irradiated region.

When particles attached to the surface of matrix metal particles had a low thermal conductivity but had an average particle size more than 300 nm, neither the increase in building speed nor the improvement in precision of the produced three-dimensional object was achieved (powder material 14). This is presumably because the excessively large distance between the matrix metal particles made it difficult for the matrix metal particles to be sintered or fused together and thus led to a failure to increase the building speed and because the adjacent matrix metal particles were too distant from each other in the formed thin layer and thus underwent insufficient sintering or fusion which led to decrease in precision of the three-dimensional object.

When the thermal conductivity of the particles attached to the surface of the matrix metal particles was higher than the thermal conductivity of the matrix metal particles, neither the increase in building speed nor the improvement in precision of the produced three-dimensional object was achieved (powder material 15). This is presumably because heat diffused between the adjacent matrix metal particles via the particles attached to the surface of the matrix metal particles and the heat diffusion inhibited the temperature increase of the matrix metal particles and caused partial sintering or fusion of the matrix metal particles in a non-laser-irradiated region.

When the particles attached to the surface of the matrix metal particles had a lower thermal conductivity than the matrix metal particles but the thermal conductivity of the attached particles was more than 35.0 W/K·m, neither the increase in building speed nor the improvement in precision of the produced three-dimensional object was achieved (powder material 16). This is presumably because heat diffused between the adjacent matrix metal particles via the particles attached to the surface of the matrix metal particles and the heat diffusion inhibited the temperature increase of the matrix metal particles and caused partial sintering or fusion of the matrix metal particles in a non-laser-irradiated region.

When the average particle size of the matrix metal particles was less than 20 μm, neither the increase in building speed nor the improvement in precision of the produced three-dimensional object was achieved (powder material 17). This is presumably because the composite particles were difficult to uniformly spread due to reduced flowability, and the matrix metal particles were irradiated with only a small amount of laser beam due to their small size of the matrix metal particles, so that the matrix metal particles were not readily sintered or fused together.

With the use of a powder material produced by mixing copper particles having an average particle size of 40 μm and mixed copper particles having an average particle size of 25 nm, neither the increase in building speed nor the improvement in precision of the produced three-dimensional object was achieved (powder material 18). This is presumably because the copper particles having an average particle size as small as 25 nm did not provide sufficient distances between the matrix metal particles, and many of the matrix metal particles were in direct contact with each other in the formed thin layer due to a failure of the copper particles to reside between the matrix metal particles, so that heat diffused between the adjacent matrix metal particles to a significant extent and the heat diffusion inhibited the temperature increase of the matrix metal particles and caused partial sintering or fusion of the matrix metal particles in a non-laser-irradiated region.

The present application claims priority based on Japanese Patent Application No. 2016-118054 filed on Jun. 14, 2016, the contents of the claims, description, and drawings of which are incorporated herein.

### INDUSTRIAL APPLICABILITY

With the powder material according to the present invention, a faster building speed and a higher precision of the three-dimensional object produced can be achieved than with conventional powder materials. The present invention is therefore expected to contribute to further widespread use of three-dimensional shaping by powder bed fusion process using a metal material.

### REFERENCE SIGNS LIST

100 Composite particle
110 Matrix metal particle
120 Low thermal conductivity particle
400 Three-dimensional shaping apparatus
410 Build stage
420 Thin layer formation section
421 Powder feed section
422 Recoater driving section
422a Recoater
430 Temperature regulation section
431 First temperature regulator
432 Second temperature regulator
435 Temperature measurement device
440 Laser irradiation section
441 Laser light source
442 Galvano mirror driving section
442a Galvano mirror
443 Laser window
450 Stage support section
460 Control section
470 Display section
475 Operation section
480 Memory section
485 Data input section
490 Base
500 Computer apparatus

1. A powder material comprising a plurality of composite particles, the powder material being intended for use in producing a three-dimensional object by selectively irradiating a thin layer of the powder material with a laser beam to form an object layer composed of the composite particles sintered or fused together and stacking the object layer on another, wherein
the composite particles comprise matrix metal particles having a number-average particle size of 20 μm or more and 60 μm or less and low thermal conductivity particles having a number-average particle size of 100 nm or more and 300 nm or less, the low thermal conductivity particles being attached in the form of islands to the surface of each matrix metal particle, and
the low thermal conductivity particles have a thermal conductivity at 100° C. of 35.0 W″K·m or less, and the thermal conductivity at 100° C. of the low thermal conductivity particles is lower than a thermal conductivity at 100° C. of a metal material contained as a main component in the matrix metal particles.

2. The powder material according to claim 1, wherein a ratio (B/A) of the number-average particle size (B) of the low thermal conductivity particles to the number-average particle size (A) of the matrix metal particles is 0.005 or more.

3. The powder material according to claim 1, wherein the matrix metal particles have a particle size distribution with a coefficient of variation (CV value) of 15% or less.

4. The powder material according to claim 1, wherein the low thermal conductivity particles have a particle size distribution with a coefficient of variation (CV value) of 15% or less.

5. The powder material according to claim 1, wherein the low thermal conductivity particles contain a metal oxide as a main component.

6. The powder material according to claim 1, wherein the degree of coverage of the surface of each matrix metal particle by the low thermal conductivity particles is 5% or more and 50% or less.

7. The powder material according to claim 1, wherein a ratio (L/A) of an average (L) of distances between the adjacent low thermal conductivity particles on the surface of each matrix metal particle to the number-average particle size (A) of the matrix metal particles is 0.10 or less.

8. A method of producing the powder material according to claim 1, comprising:
providing matrix metal particles having a number-average particle size of 20 μm or more and 60 μm or less and low thermal conductivity particles having a number-average particle size of 100 nm or more and 300 nm or less and a thermal conductivity at 100° C. of 35.0 W/K·m or less, wherein the thermal conductivity at 100° C. of the low thermal conductivity particles is lower than a thermal conductivity at 100° C. of a metal material contained as a main component in the matrix metal particles; and
attaching the low thermal conductivity particles to the surface of each matrix metal particle to fabricate composite particles.

9. A method of producing a three-dimensional object, comprising:
forming a thin layer of the powder material according to claim 1 or the powder material produced by the method according to claim 8;
selectively irradiating the thin layer with a laser beam to sinter or fuse the composite particles contained in the powder material and form an object layer composed. of the sintered or fused composite particles; and
repeating the formation of the thin layer and the formation of the object layer in the order mentioned to stack the object layers on top of one another.

10. A three-dimensional shaping apparatus comprising:
a build stage;
a thin layer formation section that forms a thin layer of the powder material according to claim on or above the build stage;
a laser irradiation section that irradiates the thin layer with a laser to form an object layer composed of the composite particles sintered or fused together;
a stage support section supporting the build stage and capable of changing the position of the build stage in a vertical direction; and
a control section that controls the think layer forming section, the laser irradiation section, and the stage support section to repeat formation of the object layer and stack the object layers on top of one another.
